(19) United States
(12) Patent Application Publication
(10) Pub. No.: US 2007/0160734 A1
(43) Pub. Date: Jul. 12, 2007

(54) Beverage emulsion

(75) Inventors: Reginald Van Bokkelen, Braine-l' Alleud (BE); Bjarne Fallesen, Nakskov (DK)

Correspondence Address: STEPTOE & JOHNSON LLP, 1330 CONNECTICUT AVENUE, N.W., WASHINGTON, DC, 20036, US

(73) Assignee: Danisco A/S, Copenhagen (DK)

(21) Appl. No.: 11/635,655

(22) Filed: Dec. 8, 2006

Related U.S. Application Data
(60) Provisional application No. 60/748,590, filed on Dec. 9, 2005.

(51) Int. Cl. A23L 2/00

(52) U.S. Cl. 426/590

(57) ABSTRACT

Novel beverage emulsions using pectin as an emulsifier are disclosed, along with finished beverages and processes for their preparation.

This application claims priority under 35 USC §119(e) to U.S. Provisional Application Ser. No. 60/748,590, filed on Dec. 9, 2005, the entire contents of which is hereby incorporated by reference.

### FIELD OF THE INVENTION

The present invention relates to a beverage emulsion, beverages comprising such emulsions, and processes for the preparation of such emulsions. In particular, the present invention relates to cola-type emulsions.

### BACKGROUND

Beverage emulsions are a well-known class of foodstuff. They consist of a continuous aqueous phase in which a discontinuous oil phase is dispersed in the form of microscopic droplets. They are thus characterised as oil-in-water (O/W) emulsions.

The oil phase may comprise one or more lipophilic ingredients which would otherwise be immiscible in the beverage, such as flavour oils.

Cola type beverages emulsions are used to maintain a stable beverage including flavour oils that are not otherwise soluble.

The formulation requirements placed upon such a beverage emulsion are very demanding. They must be stable, both as concentrate and diluted (i.e. finished) beverage, over a wide range of temperatures and storage conditions, whilst also being straightforward to formulate and incorporate into beverages.

Beverage emulsions are by their nature thermodynamically unstable and tend to break down on storage. The most common manifestations of beverage emulsion deterioration are “ringing” and “sedimentation”. Ringing is the formation of a whitish ring around the neck of the container, whilst sedimentation is the precipitation of material at the bottom.

Two main approaches have been employed in an attempt to control beverage emulsion stability:

i. reduction of the droplet size of the dispersed (i.e. oil) phase.

ii. reduction of the turbitity of the emulsion.

Droplet size is normally controlled by means of a combination of the process employed to obtain the emulsion, and the nature of the emulsifier used. A homogenisation pressure of 150 to 300 bars has been found to give good results in terms of emulsion stability.

Gum arabic is the emulsifier of choice in beverage emulsions. However, gum arabic is a natural exudate gum produced by Acacia senegal, a shrub best suited to arid regions of Africa. Thus, its availability and price are subject to fluctuations in the political and climatic conditions in this region of the world.

Various potential replacements for gum arabic have been suggested, notably modified starch. However, they can adversely affect the flavour and mouthfeel of the beverage product, especially if relatively large quantities of emulsifier are required. When included in the beverage products at higher levels, some emulsifiers can additionally destabilize the beverage emulsion. In addition, many carbohydrate gums are relatively expensive.

Sugar beet pectin has been identified as a possible replacement for gum arabic in beverage emulsions. Sugar beet pectin is obtained from sugar beet pulp, and is available at an economically attractive price; it is a naturally occurring material, and is thus more widely accepted by consumers and regulatory authorities; and it imparts no unpleasant flavours or undesirable mouthfeel characteristics to formulated beverages.

### PRIOR ART

U.S. Pat. No. 5,008,254 discloses pectins derived from high temperature, controlled hydrolytic aqueous extraction of spent sugar beet pulp, and their use as functional ingredients in comestibles. The pectins thus prepared are stated to have excellent properties in stabilising emulsions of citrus oils in water. A flavour oil emulsion is disclosed, comprising California orange oil adjusted to a density of 1.046 with brominated vegetable oil, together with an aqueous phase and a sugar beet pectin emulsifier.

Although the emulsions thus obtained are of comparable stability with emulsions employing gum arabic as emulsifier, after three months' storage, some gravitational sedimentation could be observed.

DE 4313549 discloses a process for obtaining pectin extract from sugar beet, omitting the otherwise customary stage of alcoholic precipitation. The obtained pectin is particularly suitable for the stabilisation of food emulsions.

U.S. Pat. No. 6,663,717 B2 discloses a method of simultaneous purification and separation of pectin and pectic sugars/oligomers from sugar beet pulp. The obtained pectins are stated to be useful as emulsifiers.

Application note 0002082-02 (Copenhagen Pectin A/S, a division of Hercules Incorporated) discloses a beverage emulsion comprising; i) an oil phase consisting of orange oil weighted with ester gum 8BG blended to a density of 0.93; ii) water; and iii) GENU pectin type BETA. The ester gum is stated to retard the instability phenomenon known as Ostwald ripening.

Publication FA O 5.13.09-02 “Flavour Oil Emulsion with XPQ-EMP 3” (Degussa Texturant Systems) discloses the use of sugar beet pectin in the preparation of beverage emulsions. The oil phase in this emulsion comprises orange oil together with weighting agent.

Publication “GENU pectin type BETA for flavour oil emulsions” (CPK Kelco, Denmark, 1999) discloses GENU pectin type BETA (sugar beet pectin) as an emulsifier for use in flavour oil emulsions. Hercules ester gum 8BG is recommended as an oil phase weighting agent to avoid problems of creaming off.

Conference paper “Lecture of the Master Class on Emulsion Technology” held at FI Food Ingredients Europe, 3-5 Nov. 1998, Frankfurt, Germany (Herbstreith & Fox) discloses oil in water emulsions employing sugar beet pectin as emulsifier. The oil phase comprises citrus oil weighted with ester gum to a density of 0.968 g/ml. The conclusion of this paper is that sugar beet pectin is unsuitable for emulsions comprising high amounts of oil.

J. Agric. Food Chem. 2005, 53, 3592-3597 discloses the emulsification properties of sugar beet pectin and its fractions. Ester gum and orange oil are mixed in a 1:1 ratio. Oil in water emulsions are prepared using 10% ester gum/orange oil mixture and 0.5 to 5% sugar beet pectin.

When pectin is used to stabilise an emulsion, generally amounts of 2% wt of pectin or more are employed. Higher amounts are, generally employed if the emulsion does not contain any weighting agents. Whilst the use of higher amounts of pectin will increase the emulsifying capacity of the mixture when an homogenising step is carried out, it may also trigger the problem of flocculation by depletion.

WO0232236 discloses calcium supplemented cola type beverages.

U.S. Pat. No. 5,900,268 concerns the use of pectin as an emulsifying and stabilizing agent. It is used e.g. in the emulsions in soft drinks. The pectin used originates from apple or citrus fruit. When producing the beverage emulsion the oil and aqueous phases are mixed with each other and the mixture is homogenized.

WO 03/096824 concerns flavored ‘oil in water’—emulsions for beverages, like e.g. soft drinks. The emulsions in question contain pectin, and homogenization is used in the production of the emulsions. The pectin used is HM-pectin (high methoxyl), like sugar beet pectin.

WO 03/015537 concerns carotenoid compositions used as colour agents or additives in beverages including sugar beet pectin. The compositions in question can be in the form of emulsions.

WO 2004/000041 concerns stable ‘oil in water’—emulsions used in foodstuffs including pectin, e.g. sugar beet pectin.

GB 1082284 concerns caramellized eatable emulgated oil composition and its production. The composition in question can be added to soft drinks. Also the extract of cola nut can be added. The publication describes also the addition of pectin in the production of emulsion.

WO 03/003849 concerns fatty acid compositions comprising pectin, and which can be used in beverages. The publication mentions also the cola drinks as beverages.

US 2003/0064143 concerns clear beverages comprising pectin, e.g. soft drinks like cola type beverages.

According to U.S. Pat. No. 6,576,276 pectin and guar gum are dissolved into water and added in coke syrup. The publication describes the use of pectin as an emulsifying agent in citrus oil emulsions used in soft drinks.

EP 868854 describes the use of pectin as a stabilizing agent in beverages.

‘OPPORTUNITIES AND LIMITS FOR THE USE OF PECTIN AS AN EMULSIFIER. II’. EUROPEAN FOOD & DRINK REVIEW, (1999), AUTUMN, p. 53-54, 56, (ABSTRACT) FSTA 2000(07) concerns the possibilities to use pectin as an emulsifying agent in citrus oil emulsions used in beverages.

ROLIN C., ‘PECTIN—LABEL FRIENDLY, CONSISTENT, VERSATILE’. EUROPEAN FOOD AND DRINK REVIEW, 1994, (AUTUMN), p. 61-62, 65 concerns the use of pectin including among others the use of pectin as an emulgator in the flavored oils for the soft drinks.

HOEFLER A. C., ‘OTHER PECTIN FOOD PRODUCTS’. THE CHEMISTRY AND TECHNOLOGY OF PECTIN., PUBLISHED BY: ACADEMIC PRESS, LONDON, 1991, p. 56-66 concerns the use of pectin as an emulsifying and stabilizing agent, and its addition to beverages.

The inventors of the present invention have assessed the compositions of the prior art, and determined that while in most instances the concentrated formulations give somewhat stable beverage emulsions, when finished beverages are prepared, prominent whitish neck ring is often observed within 48 hours whenever manufactured under conditions mimicking those in a bottling plant.

A problem that the prior art does not solve is the provision of beverage emulsions employing sugar beet pectin as emulsifier having reduced phase separation on storage both as beverage emulsions and finished beverages.

A further problem that the prior art does not solve is the provision of beverage emulsions employing sugar beet pectin as emulsifier which can be stored at ambient or below ambient (i.e. below 20° C.) temperature without gelification and/or microbial contamination.

A further problem that the prior art does not solve is the provision of beverage emulsions that are compatible with current processing conditions at a bottling plant.

A further problem that the prior art does not solve is the provision of alternative stabilisers for use in cola type beverages.

A further problem that the prior art does not solve is the compatibility problems of using pectin and caramel in cola-type beverages.

The present invention addresses one or more of the problems associated with the prior art.

### SUMMARY OF THE INVENTION

According to a first aspect, there is provided a cola-type beverage emulsion comprising:
an oil phase;
an aqueous phase; and
pectin, wherein the emulsion comprises between 0.05% and 0.50% w/w pectin based on the total weight of the emulsion.

According to another aspect, there is provided a finished beverage comprising a cola-type beverage emulsion of the invention.

According to a further aspect, there is provided a process for the preparation of a cola-type beverage emulsion of the invention comprising the steps of:

(i) bringing into association the constituents of the oil phase and an aqueous phase comprising a mucilage component to form a mixture;

(ii) homogenising the said mixture;

(iii) bringing into association the homogenised mixture and caramel;

(iv) homogenising to form the beverage emulsion.

According to a further aspect, there is provided the use of sugar beet pectin as an emulsifier in a cola-type beverage emulsion of the invention.

According to a further aspect, there is provided a cola-type beverage comprising sugar beet pectin.

According to a further aspect, there is provided the use of sugar beet pectin as an emulsifier and/or stabiliser in a cola-type beverage.

### DETAILED DESCRIPTION OF THE INVENTION

As used herein, the term “cola type beverage” refers to a beverage comprising an oil phase and an aqueous phase in a stable emulsion.

Preferably, the cola type beverage comprises caramel. Such beverages will have a typical brown appearance. However, the term cola type beverage also comprehends beverages not including caramel, such as clear (colourless) beverages.

Preferably, the cola type beverage comprises caffeine. Optionally, the cola type beverage comprises kola nut or extract of kola nut.

As used herein, the term “cola-type beverage emulsion” refers to an emulsion suitable for the preparation of a cola type beverage. Preferably, the cola type is prepared from the cola type beverage.emulsion by dilution with an aqueous component, particularly carbonated water.

The present invention provides stable oil in water emulsions employing pectin as an emulsifier. A surprising finding of the invention is that in order to obtain oil in water emulsions which are stable towards long term storage both as concentrates and as finished (i.e. diluted) beverages, whilst utilising pectin as an emulsifier, it is necessary to balance the emulsifying capacity of pectin with the possibility that the pectin may trigger flocculation by depletion.

It has also been found that it is important to control the incorporation of the caramel.

Oil Phase

As used herein, the term “oil phase” refers to a composition which is substantially immiscible with an aqueous phase when present as the oil component of an oil-in-water emulsion.

Preferably, the oil phase comprises one or more of the group comprising: flavour oils, antioxidants, and pigments.

Flavour Oils

The term “flavour oil” as used herein means any water-immiscible liquid that serves to impart flavour or aroma or both to the oil phase containing it.

Suitable flavours include: fruit flavours, such as guava, kiwi, peach, mango, papaya, pineapple, banana, strawberry, raspberry, blueberry, orange, grapefruit, tangerine, lemon, lime, lemon-lime, etc.; cola flavours; tea flavours; coffee flavours; chocolate flavours; dairy flavours; root beer and birch beer flavours, such as methyl salicylate (wintergreen oil, sweet birch oil), and oils including nutmeg, bergamot cinnamon, cassia, neroli, coriander and lavender. In citrus-flavoured beverage products the flavour oil typically contains several citrus oils of different types so that a well-balanced flavour is produced. Citrus oils may contain more than 90% by weight mono-terpenes and a smaller amount of sesqui-terpenes. Both are carriers of the oxygenated. terpenoids, specifically the alcohols, aldehydes, ketones, acids, and esters, that are responsible for the characteristic aroma and flavour profile of the oil.

Weighting Agents

The term “weighting agent” as used herein refers to a water immiscible component which is soluble or miscible in the oil phase, which has a density of greater than 1.00 gcm⁻³ at 20° C. Cola-type beverages generally do not comprise weighting agents, although their use is known.

Examples of weighting agents for adjusting the density of the oil phases of the invention include ester gum, damar gum, brominated vegetable oil (BVO) sucrose acetate iso-butyrate (SAIB), glycerol tribenzoate and decaglycerol esters. The oil phase of the invention may comprise one or more than one weighting agent.

Ester gum is produced by esterification of pale wood rosin with food grade glycerol. Wood rosin, a solid resinous material found in the oleoresin of pine trees, contains about 90% by weight resin acids, primarily abietic acid and pimeric acid, and about 10% by weight non-acidic neutral components. Ester gum is prepared by esterification of the wood rosin with glycerol, which produces a mixture of mono-, di-, and triglycerides. After removal of the excess glycerine by vacuum distillation and steam sparging, the wood rosin typically has a specific gravity of about 1.08 at 25° C. Currently, ester gum is approved by the United States and a number of other countries as a food additive.

Damar gum refers to a group of water-insoluble natural exudates from shrubs of the Genus Dammar, especially the Caesalpinaceae and Dipterocarpacae families, which are indigenous to Malaysia, Indonesia, and the East Indies. It is highly soluble in essential oils and is typically used as a weighting agent in cloud emulsions. Damar gum typically has a specific gravity of about 1.04 to 1.08 at 20° C.

Brominated vegetable oil (BVO) refers to unsaturated vegetable oil that has been reacted with elemental bromine. Brominated vegetable oil typically has a specific gravity of 1.23-1.33 at 20° C.

Sucrose acetate isobutyrate (SAIB) is a mixture of sucrose esters containing about 2 mol of acetate and 6 mol of isobutyrate per mol of sucrose, primarily 6,6′-diacetyl-2,3,4,1′, 3′, 4′-hexa-isobutyryl sucrose. It is produced by esterification of sucrose with acetic anhydride. Sucrose acetate isobutyrate is a tasteless, odourless, and colourless viscous liquid with a specific gravity of about 1.146 at 20° C.

Clouding Agents

The term “clouding agent” as used herein refers to a water immiscible component which is soluble or miscible in the oil phase as defined above, which serves to increase the “cloudiness” or turbidity of the emulsion comprising said oil phase.

Preferred clouding agents include vegetable oils (such as rapeseed, peanut, corn, flaxseed, soybean, sunflower, cottonseed and combinations and blends thereof), partially and fully hydrogenated vegetable oils, and oil replacements such as esterified epoxide extended polyols (EEEPs).

In one embodiment, between 0.5 to 40.0% w/w of clouding agents may be used based on the total weight of the oil phase.

Antioxidant

The term “antioxidant” as used in this context refers to a water immiscible component which is soluble or miscible in the oil phase as defined above and serves to prevent the oxidation and/or rancidification of said oil phase.

Preferred antioxidants are tocopherols, butylated hydroxyanisole (BHA) and butylated hydroxytoluene (BHT).

Other Components

As the skilled person will appreciate, the oil phase may include one or more other components which are immiscible with the aqueous phase but are miscible or soluble within the said oil phase, and serve to provide desirable functional characteristics to the oil phase, the beverage emulsion comprising said oil phase, or the finished beverage of the invention.

Other components include dyes, preservatives and vitamins.

Density

The term “density” as used herein refers to the mass per unit volume of a particular composition. Density is measured by a Densitometer (Density Meter DMA 38, Anton Paar) according to protocol 2 below. Measurement is conducted at 20° C. Throughout (unless otherwise specified), density is expressed in gcm⁻³.

For the avoidance of doubt, term “density of the oil phase” refers to the density of the oil phase in isolation (i.e. not the density when present in an emulsion).

Preferably, the density of the oil phase is at least 0.75 gcm⁻³. More preferably, the density of the oil phase is at least 0.80 gcm⁻³. More preferably, the density of the oil phase is at least 0.84 gcm⁻³. More preferably, the density of the oil phase is at least 0.87gcm⁻³.

Preferably, the density of the oil phase is below 1.00 gcm⁻³. More preferably, the density of the oil phase is below 0.95 gcm⁻³. More preferably, the density of the oil phase is below 0.90 gcm⁻³. More preferably, the density of the oil phase is below 0.89 gcm⁻³

Preferably, the density is in a range between any of the preferred limits referred to above. More preferably, the density is between 0.84 and 1.00 gcm⁻³. More preferably, the density is between 0.85 and 0.90 gcm⁻³. More preferably, the density is between 0.87 and 0.89 gcm⁻³. The skilled person will appreciate that in a multi-component system such as the oil phase of the invention, it is not always possible to predict the viscosity and density based on the identity of the components. A degree of routine trial and error will be required. Detailed procedures for the determination of viscosity and density are given in examples 1 and 2 respectively.

The skilled person will moreover appreciate that although the properties discussed above relate to those of the isolated oil phase, in practice it may be unnecessary or undesirable to prepare the isolated oil phase; it may be more convenient to prepare an emulsion comprising such an oil phase:

Cola-Type Beverage Emulsions

The term “emulsion” as used herein refers to a mixture of two immiscible (unblendable) substances. One substance (the dispersed phase) is dispersed in the other (the continuous phase).

Preferably, the aqueous phase is the continuous phase, and the oil phase is the dispersed phase; that is, the emulsior is an oil-in-water emulsion.

Aqueous Phase

As used herein, the term “aqueous phase” refers to a water-based composition which is substantially immiscible with the oil phase when present as the continuous component of a beverage emulsion of the invention. Cola-type beverages preferably comprise caramel in the aqueous phase of the emulsion.

An advantage of the present invention is that the cola type beverage emulsions obtained are stable even when large amounts of caramel are present.

The aqueous phase may contain one or more ingredients customary in the production of beverage emulsions. Preferably, the aqueous phase may comprise one or more of the following:

sweeteners such as sugars, low calorie sweeteners, and reduced calorie sweeteners;

sugars including sucrose;

low calorie sweeteners including acesulfame K, alitame, aspartame, cyclamate, neohesperidin dihydrochalcone, tagatose, neotame, saccharin, stevioside, and sucralose;

reduced calorie sweeteners including erythritol, hydrogenated starch hydrolysates and maltitol syrup, isomalt, maltitol, lactitol, sorbitol and mannitol, xylitol, crystalline fructose, high-fructose corn syrup, isomaltulose, trehalose, fructooligosaccharides and polydextrose (such as Litesse®);

water soluble flavourings;

water soluble colourings;

caffeine;

glycerine;

acids including citric acid, malic acid and phosphoric acid, and the food acceptable salts thereof;

water soluble preservatives including sorbic acid, benzoic acid and the food acceptable salts thereof, especially the sodium and potassium salts

additional emulsifiers including gum arabic, modified starch, xanthan gum, lecithin and other polysaccharides.

Preferably, the aqueous phase comprises citric acid. More preferably, the aqueous phase comprises citric acid in an amount of between 0.1% w/w and 0.5% w/w based on the weight of the emulsion.

Preferably, the aqueous phase comprises sodium benzoate. More preferably, the aqueous phase comprises sodium benzoate in an amount of between 0.05% w/w and 0.1% w/w based on the weight of the emulsion.

In an alternative preferred embodiment, the aqueous phase comprises both sodium benzoate and potassium sorbate in a combined amount of between 0.05% w/w and 0.18% w/w based on the weight of the emulsion.

Preferably, the pH of the aqueous phase is between 1 and 7. More preferably, the pH of the aqueous phase is between 2.5 and 4. More preferably, the pH of the aqueous phase is between 3.2 and 3.8.

Preferably, the aqueous phase is present in an amount of from 95.0 to 99.7% w/w based on the weight of the beverage emulsion. More preferably, the aqueous phase is present in an amount of from 98.0 to 99.7% w/w based on the weight of the beverage emulsion. More preferably, the aqueous phase is present in an amount of from 98.5 to 99.5% w/w based on the weight of the beverage emulsion. Preferably, the oil phase is present in an amount of from 0.3 to 5.0% w/w based on the weight of the beverage emulsion. More preferably, the oil phase is present in an amount of from 0.3 to 2.0% w/w based on the weight of the beverage emulsion. More preferably, the oil phase is present in an amount of from 0.5 to 1.5% w/w based on the weight of the beverage emulsion.

Pectin

The aqueous phase of the emulsions of the invention comprises at least a pectin. The term “pectin” as used herein, unless otherwise specified, may refer to pectin of one specific origin or more than one origin.

Pectin is a structural polysaccharide, a polymeric carbohydrate of a high molecular weight, commonly found in the form of protopectin in plant cell walls. Pectin has an EU-number E 440 and US FDA reference 184.1588 (GRAS). Pectin molecules typically have a molecular weight of up to 150,000 and a degree of polymerisation of up to 800 units. Pectin has an important influence on plant cells, since it is protopectin and cellulose that form the structure of the cell walls.

The backbone of pectin comprises α-1-4 linked galacturonic acid residues which are interrupted with a small number of 1,2 linked α-L-rhamnose units. In addition, pectin comprises highly branched regions with an almost alternating rhamno-galacturonan chain. These highly branched regions also contain other sugar units (such as D-galactose, L-arabinose and xylose) attached by glycosidic linkages to the C3 or C4 atoms of the rhamnose units or the C2 or C3 atoms of the galacturonic acid units. The long chains of α-1-4 linked galacturonic acid residues are commonly referred to as “smooth” regions, whereas the highly branched regions are commonly referred to as the “hairy regions”.

Preferably, the pectin used in the emulsion of the invention has a galacturonic acid content of between 50 and 85%. More preferably, the pectin has a galacturonic acid content of between 65 and 80%.

Commercial pectin is commonly derived from the peel of citrus fruits (lemon, lime, orange and grapefruit), or from apple pomace, all of which releasing pectin of superior quality for the purposes of gel formation.

Sugar beet pectin is extracted from sugar beet pulp subsequent to sugar extraction. It is generally considered inferior in terms of gelation properties when compared with citrus or other pectins.

Various chemically or enzymatically modified pectins are also contemplated within the term “pectin”. For example, the pectin may be a high ester pectin. “High ester pectin” refers to a pectin in which the degree of esterification or DE is greater than or equal to 50%. High ester pectins are also known as “HE pectin”.

Alternatively, the pectin may be a low ester pectin. “Low ester pectin” refers to a pectin in which the degree of esterification or DE is less than 50%. Low ester pectins are also known as “LE pectin”.

Preferably, the pectin of the composition has a degree of esterification (DE) of between 55 and 60%.

Preferably, the pectin of the composition has a degree of acetylation of between 5 and 50%. More preferably, the pectin of the composition has a degree of acetylation of between 10 and 50%. More preferably, the pectin of the composition has a degree of acetylation of between 10 and 40%. Most preferably, the degree of acetylation is between 15 and 35%.

Preferably, the pectin comprises at least sugar beet pectin. More preferably, the pectin consists essentially of sugar beet pectin. Still more preferably, the pectin consists essentially of sugar beet pectin as the sole emulsifier.

Preferably, the average molecular weight of the pectin is above 10 kDa. More preferably, the average molecular weight of the pectin is above 15 kDa. Still more preferably, the average molecular weight of the pectin is above 20 kDa. Still more preferably, the average molecular weight of the pectin is above 25 kDa. Still more preferably, the average molecular weight of the pectin is above 30 kDa. Still more preferably, the average molecular weight of the pectin is above 35 kDa. Still more preferably, the average molecular weight of the pectin is above 40 kDa. Most preferably, the average molecular weight of the pectin is above 45 kDa.

Preferably, the average molecular weight of the pectin is below 100 kDa. More preferably, the average molecular weight of the pectin is below 90 kDa. Still more preferably, the average molecular weight of the pectin is below 80 kDa. Still more preferably, the average molecular weight of the pectin is below 70 kDa. Most preferably, the average molecular weight of the pectin is below 65 kDa.

Preferably, the average molecular weight of the pectin is in a range between any of the preferred limits referred to above. More preferably, the average molecular weight of the pectin is in a range between 15 and 100 kDa. Still more preferably, the average molecular weight of the pectin is in a range between 30 and 100 kDa. Still more preferably, the average molecular weight of the pectin is in a range between 15 and 70 kDa. Still more preferably, the average molecular weight of the pectin is between 10 and 60 kDa. Still more preferably, the average molecular weight of the pectin is in a range between 15 and 100 kDa. Still more preferably, the average molecular weight of the pectin is in a range between 30 and 70 kDa. Still more preferably, the average molecular weight of the pectin is between 45 and 70 kDa. Still more preferably, the average molecular weight is between 30 and 65 kDa. Most preferably, the average molecular weight is between 45 and 65 kDa.

Preferably, the beverage emulsion comprises between 0.05 and 1.00% w/w of pectin based on the total weight of the emulsion. More preferably, the beverage emulsion comprises between 0.05 and 0.50% w/w of pectin based on the total weight of the emulsion. More preferably, the beverage emulsion comprises between 0.05 and 0.30% w/w of pectin based on the total weight of the emulsion. More preferably, the beverage emulsion comprises between 0.05 and 0.10% w/w of pectin based on the total weight of the emulsion.

Stability

Preferably, the beverage emulsions of the invention are stable upon storage. In this context, “stable” means that the stored emulsion passes the “ringing test” described by Tan and Holmes, “Stability of beverage flavour emulsions”, Perfumer and Flavourist 1988, 13, 23-41 (see protocol 3).

Preparation of Beverage Emulsions

The cola-type beverage emulsions of the invention are suitably prepared by a process comprising:

(i) bringing into association the constituents of the oil phase and an aqueous phase comprising a mucilage component to form a mixture;

(ii) homogenising the said mixture;

(iii) bringing into association the homogenised mixture and caramel;

(iv) homogenising to form the beverage emulsion.

The step of bringing the oil phase and aqueous phase may be accomplished in any one of a number of ways. For example, the oil phase may be added to the aqueous phase; alternatively, the aqueous phase may be added to the oil phase. However, it is not necessary to prepare the oil phase or aqueous phase prior to bringing them into association, and in an alternative process the constituents of the aqueous phase and the constituents of the oil phase may be added together in any convenient order.

In one preferred embodiment of the invention, however, the oil phase and the aqueous phase are prepared separately before being combined.

Homogenising, as used herein, refers to a process whereby the aqueous phase and oil phase are transformed into a stable emulsion of oil phase particles within the continuous water phase.

Preferably, the homogenising process is conducted in two steps, namely preliminary homogenisation and final homogenisation. Preferably, final homogenisation is conducted after preliminary homogenization.

Preliminary homogenisation is a process step which results in the oil phase particles obtaining a particle size of from 0.5 to 1.2 μm, more preferably from 0.5 to 1.0 μm.

Preliminary homogenisation may be achieved in a variety of ways known to those in the art. Suitable methods for achieving preliminary homogenisation include the use of a high speed mixer, a hydroshear mixer, a homomixer, or single pass homogenisation at a pressure of between 0 and 50 bar.

Final homogenisation is a process step which results in the oil phase particles obtaining a particle size of from 0.3 to 1.0 μm.

Final homogenisation may be achieved in a variety of ways known to those in the art. Preferably, the emulsion obtained as a result of preliminary homogenisation above is passed through a homogeniser at a pressure of between 150 to 300 bar, more preferably at a pressure of between 200 and 250 bar. Preferably, said emulsion is passed through the homogeniser more than once. More preferably, said emulsion is passed through the homogeniser 2 or 3 times. Most preferably, said emulsion is passed through the homogeniser 2 times.

Mucilage Component

As is known in the art, pectin may form a gelatanous gum or mucilage component in solution. This component may also include other components such as citric acid and preservatives.

Finished Beverages

The beverage emulsions of the present invention may be combined with water and one or more ingredients customary in the art to give a beverage in a form suitable for consumption (“finished beverage”).

Preferably, the finished beverages comprise between 0.01 and 1.00% w/w of the beverage emulsions of the invention based on the weight of the finished beverage. More preferably, the finished beverages comprise between 0.02 and 0.40% w/w of the beverage emulsions of the invention based on the weight of the finished beverage. More preferably, the finished beverages comprise between 0.10 and 0.40% w/w of the beverage emulsions of the invention based on the weight of the finished beverage. More preferably, the finished beverages comprise between 0.10 and 0.20% w/w of the beverage emulsions of the invention based on the weight of the finished beverage.

The finished beverage may be still. Alternatively, the finished beverage may be carbonated. Suitably, the finished beverage is carbonated in the range of 0 to 4.5% v/v.

The finished beverage may contain alcohol. Preferably, the finished beverage contains alcohol in an amount of between 0.01 and 15% v/v based on the volume of the finished beverage.

Preferably, the finished beverage is between 0 and 15° Brix.

Preferably, the finished beverage may comprise one or more of the following (in addition to those components present in the beverage emulsion):

sugars including sucrose;

low calorie sweeteners including acesulfame K, alitame, aspartame, cyclamate, neohesperidin dihydrochalcone, tagatose, neotame, saccharin, stevioside, and sucralose;

reduced calorie sweeteners including erythritol, hydrogenated starch hydrolysates and maltitol syrup, isomalt, maltitol, lactitol, sorbitol and mannitol, xylitol, crystalline fructose, high-fructose corn syrup, isomaltulose, trehalose, fructooligosaccharides and polydextrose (such as Litesse®);

water soluble flavourings;

water soluble colourings;

caffeine;

fruit juices including guava, kiwi, peach, mango, papaya, pineapple, banana, strawberry, raspberry, blueberry, orange, grapefruit, tangerine, lemon, lime, lemon-lime and apple;

acids including citric acid, malic acid and phosphoric acid, and the food acceptable salts thereof;

water soluble preservatives including sorbic acid, benzoic acid and the food acceptable salts thereof, especially the sodium and potassium salts

additional emulsifiers including gum arabic, modified starch, xanthan gum, lecithin and other polysaccharides.

Preferably, the finished beverage comprises citric acid. More preferably, the finished beverage comprises citric acid in an amount of between 0.1% w/w and 0.5% w/w based on the weight of finished beverage.

Preferably, the finished beverage comprises sodium benzoate. More preferably, the finished beverage comprises sodium benzoate in an amount of up to 350 ppm.

In an alternative preferred embodiment, the finished beverage comprises both sodium benzoate and potassium sorbate in a combined amount of up to 350 ppm.

The finished beverages may suitably be prepared according to the postmix or premix methods.

After formulation, the finished beverage may suitably be pasteurized using a method known in the art. For example, the finished beverage may be treated at between 85 and 87° C. for between 20 and 30 seconds.

The finished beverages thus produced exhibit excellent, stable levels of cloudiness. Additionally, they are stable for extended periods with no evidence of ringing or sedimentation.

Cola Type Beverage

Cola-type beverages are clear, non-cloudy, beverages.

According to a further aspect, there is provided a cola-type beverage comprising sugar beet pectin.

Preferably, the cola type beverage comprises sugar beet pectin as an emulsifier and/or stabiliser.

More preferably, the cola type beverage comprises sugar beet pectin as the sole emulsifier.

More preferably, the cola type beverage comprises sugar beet pectin as the sole stabiliser.

Preferably, the cola type beverage comprises sugar beet pectin in an amount of between 0.005 and 0.200% w/w based on the total weight of the beverage. More preferably, the cola type beverage comprises sugar beet pectin in an amount of between 0.005 and 0.100% w/w based on the total weight of the beverage. More preferably, the cola type beverage comprises sugar beet pectin in an amount of between 0.05 and 0.10% w/w based on the total weight of the beverage.

The cola type beverage will preferably include one or more ingredients typical of such comestibles. These include:

flavours, especially flavour oils, such as cola, lemon, lime and vanilla; also including liquorice flavour;

caramel;

sweeteners such as sugars, low calorie sweeteners, and reduced calorie sweeteners;

sugars including sucrose;

low calorie sweeteners including acesulfame K, alitame, aspartame, cyclamate, neohesperidin dihydrochalcone, tagatose, neotame, saccharin, stevioside, and sucralose;

reduced calorie sweeteners including erythritol, hydrogenated starch hydrolysates and maltitol syrup, isomalt, maltitol, lactitol, sorbitol and mannitol, xylitol, crystalline fructose, high-fructose corn syrup, isomaltulose, trehalose, fructooligosaccharides and polydextrose (such as Litesse®);

water soluble flavourings;

water soluble colourings;

caffeine;

acids including citric acid, malic acid and phosphoric acid, and the food acceptable salts thereof, especially phosphoric acid;

water soluble preservatives including sorbic acid, benzoic acid and the food acceptable salts thereof, especially the sodium and potassium salts

According to a further aspect, there is provided the use of sugar beet pectin as an emulsifier and/or stabiliser in a cola-type beverage.

In a further aspect, the cola-type beverages are clear, non-cloudy beverages that comprise an emulsion comprising particles of an oil phase that have an average particle size of less than 300 nm.

The present invention will now be described in further detail in the following examples.

### EXAMPLES

### Example 1

Preparation of a Cola-type Beverage Emulsion

A cola-type beverage emulsion was prepared using an cola flavoured oil as given in Table 1. This cola flavoured oil was used to prepare a cola integrant as given in Table 2. This cola integrant was used to prepare a cola-type beverage emulsion as given in Table 3.

TABLE 1

| Ingredient | % w/w |
|---|---|
| Cassia oil | 8.37 |
| Lime oil | 5.02 |
| Lemon oil | 10.87 |
| Cola Components | 75.32 |
| Tocopherol | 0.42 |
| TOTAL | 100 |

TABLE 2

| Ingredient | % w/w |
|---|---|
| Water | 84.51 |
| Oil Blend | 11.49 |
| Sugar beet pectin | 1.80 |
| Citric acid | 2.00 |
| Sodium benzoate | 0.10 |
| Cola flavour oil (from Table 1) | 0.10 |
| TOTAL | 100 |

TABLE 3

| Ingredient | % w/w |
|---|---|
| Caramel | 75.78 |
| Cola Integrant (from Table 2) | 0.99 |
| Vanilla | 0.03 |
| Liquorice | 0.38 |
| Cola Nut | 3.22 |
| Water | 19.60 |
| TOTAL | 100 |

A stable cola type beverage emulsion was obtained.

### Example 2

The cola-type beverage emulsion of Example 1 is combined with further ingredients in the quantities and order indicated in table 4 to provide a syrup, which further diluted into a carbonated finished drink.

TABLE 4

| Ingredient | % w/w |
|---|---|
| Sugar | 12.3 |
| Sodium benzoate | 0.013 |
| Citric acid | 0.28 |
| Cola-type beverage emulsion of example | 0.2 |
| 1 | |
| Carbonated (8 gl⁻¹) water | 87.207 |

### Example 3

A cola-type beverage emulsion was prepared using an cola flavoured oil as given in Table 5. This cola flavoured oil was used to prepare a cola flavour emulsion as set out in table 6. This cola flavour emulsion was used to prepare a cola type beverage emulsion as set out in table 7.

TABLE 5

| Ingredient | % w/w |
|---|---|
| Cassia oil | 8.37 |
| Lime oil | 5.02 |
| Lemon oil | 10.87 |
| Cola Components | 75.32 |
| Tocopherol | 0.42 |
| TOTAL | 100 |

TABLE 6

| Ingredient | % w/w |
|---|---|
| Pectin | 1.8% |
| Oil Blend of Table 5 | 11.49% |
| Water | 86.61 |
| Benzoic Acid | 0.1 |
| TOTAL | 100 |

TABLE 7

| Ingredient | Weight (Kg) |
|---|---|
| Caramel | 400 |
| Flavour emulsion of Table 6 | 52 |
| Vanilla flavour | 0.15 |
| Liquorice flavour | 2 |
| Cola nut flavour | 17 |

The cola type beverage emulsion prepared comprised 0.2% w/w of pectin. It shows good stability.

The beverage emulsion is used to prepare a finished cola type beverage by the addition of carbonated water.

### Test Protocols

Protocol 1

The viscosity of the oil phase is measured by rotational viscosimetry (Viscometer Model LVF, Brookfield, USA). Samples were placed in a thermostated MEASUREMENT (20° C.) room. The inner cylinder was driven at a constant torque or stress and the resultant strain was measured as the speed at which the inner cylinder rotated. This speed is governed by the viscosity of the fluid between the plates so that the faster it spins at a given torque, the lower the viscosity of the liquid being analyzed. Viscosity was computed from the shear stress/strain record according to the dimensional parameters of the inner cylinder. The oil phase viscosity was measured with a speed of 30 RPM at 20° C. using a LV spindle (LV 2).

Protocol 2

The density of the oil phase is measured by a Densitometer (Density Meter DMA 38, Anton Paar™). The sample to be analysed is pomped in a glass U-tube, which is forced to oscillate sinusoidally by the application of an alternating mechanical force. The density of a fluid is determined by measuring the resonant frequency of the U-tube and relating it to the density using an appropriate mathematical equation. The instrument is calibrated with two fluids of accurately known density.

Protocol 3

The “ringing test” is the most popular method to evaluate the stability of beverage flavor emulsions in soft drink. It is a test in which bottles of soft drink containing the beverage emulsion are held in an upright position at 4, 20 and 35° C. +/−2 for visualization of ringing or sedimentation during a period of at least 2 moths. Ringing test is performed as described by Tan and Holmes (1988): Stability of beverage flavour emulsions, Perfumer and Flavourist, 13: 23-41.

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry or related fields are intended to be within the scope of the following claims.

1. A cola-type beverage emulsion comprising:
an oil phase;
an aqueous phase; and
pectin, wherein the emulsion comprises between 0.05% and 0.50% w/w pectin based on the total weight of the emulsion.

2. A cola-type beverage emulsion according to claim 1 having a density of between 0.84 and 1.00 gcm⁻³ at 20° C.

3. A cola-type beverage emulsion according to claim 1 having a density of between 0.87 and 0.89 gcm⁻³ at 20° C.

4. A cola-type beverage emulsion according to claim 1 comprising citrus oil.

5. A cola-type beverage emulsion according to claim 1 comprising flavour oil.

6. A cola-type beverage emulsion according to claim 1 comprising triglyceride.

7. A cola-type beverage emulsion according to claim 1 comprising of between 0.3 and 2.0% w/w of oil phase based on the total weight of the emulsion.

8. A cola-type beverage emulsion according to claim 1 comprising between 98 and 99.7% w/w of aqueous phase based on the total weight of the emulsion.

9. A cola-type beverage emulsion according to claim 1 comprising between 0.05% and 0.30% w/w pectin based on the total weight of the emulsion.

10. A cola-type beverage emulsion according to claim 1 comprising between 0.05% and 0.10% w/w pectin based on the total weight of the emulsion.

11. A cola-type beverage emulsion according to claim 1 comprising one or more of the following: sweeteners, flavourings, colourings, caffeine, acids, preservatives, and emulsifiers.

12. A cola-type beverage emulsion according to claim 1 wherein said pectin comprises at least sugar beet pectin.

13. A cola-type beverage emulsion according to claim 1 wherein the emulsion comprises particles of oil phase having an average particle size less than 1 μm.

14. A finished cola-type beverage comprising a cola-type beverage emulsion as claimed in claim 1.

15. A finished cola-type beverage according to claim 14 wherein the beverage emulsion is present in an amount of from 0.10 to 0.40% w/w based on the total weight of the beverage.

16. A process for the preparation of a cola-type beverage emulsion as claimed in claim 1 comprising the steps of:
(i) bringing into association the constituents of the oil phase and an aqueous phase comprising a mucilage component to form a mixture;
(ii) homogenising the said mixture;
(iii) bringing into association the homogenised mixture and caramel;
(iv) homogenising to form the beverage emulsion.

17. A process according to claim 16 comprising the steps of
forming the oil phase;
forming the aqueous phase comprising a mucilage component;
bringing the oil phase and the aqueous phase comprising a mucilage component into association; and
homogenising the resultant mixture.

18. A process according to claim 16 wherein homogenising comprises steps of:
preliminary homogenisation to give an average oil phase particle size of between 0.5 and 1.2 μm; and
final homogenisation to give an average oil phase particle size of between 0.3 and 1.0 μm.

19. A process according to claim 18 wherein final homogenisation is accomplished by passing through a homogeniser at a pressure of between 150 and 300 bar.

20. A process according to claim 19 wherein the mixture is passed through the homogeniser more than once.

21. The use of sugar beet pectin as an emulsifier in a cola-type beverage emulsion as claimed in claim 1.

22. A cola-type beverage comprising sugar beet pectin.

23. A cola-type beverage according to claim 22 comprising sugar beet pectin as an emulsifier and/or stabiliser.

24. A cola-type beverage according to claim 22 comprising sugar beet pectin as the sole emulsifier.

25. A cola-type beverage as claimed in claim 22 which comprises sugar beet pectin in an amount of between 0.005 and 0.200% w/w based on the total weight of the beverage.

26. A cola type beverage as claimed in claim 22 which comprises sugar beet pectin in an amount of between 0.005 and 0.100% w/w based on the total weight of the beverage.

27. The use of sugar beet pectin as an emulsifier and/or stabiliser in a cola-type beverage.

28. A beverage emulsion comprising:
an oil phase;
an aqueous phase; and
pectin, wherein the emulsion comprises between 0.05% and 0.50% w/w pectin based on the total weight of the emulsion.
